(19) United States
(12) Patent Application Publication
(10) Pub. No.: US 2007/0130728 A1
(43) Pub. Date: Jun. 14, 2007

(54) Threaded plate

(75) Inventors: Manfred Duerr, Nagold (DE); Carmen Gutekunst, Nagold (DE); Rudolf Nowak, Boeblingen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUGGART (DE)

(21) Appl. No.: 10/578,189

(22) PCT Filed: Nov. 2, 2004
(86) PCT No.: PCT/EP04/12377

§ 371 Date: Jan. 23, 2007

(30) Foreign Application Priority Data
Nov. 4, 2003 (DE) 103 51 446.5

(51) Int. Cl. E05D 5/00

(52) U.S. Cl. 16/382

(57) ABSTRACT

A threaded plate component includes threaded sleeve which protrudes form a planar basic body. The planar basic body has at least one spacer element which protrudes thereform at an angle.

### BACKGROUND AND SUMMARY OF THE INVENTION

This application is a National Phase of PCT/EP2004/012377, filed Nov. 2, 2004, and claims the priority of German patent document DE 103 51 446.5, filed Nov. 4, 2003, the disclosure of which is expressly incorporated by reference herein.

The invention relates to a threaded plate component having a planar face with at least one threaded sleeve extending from the base.

It is known to use threaded plates in vehicle body construction, for example, to fix door hinges or closing brackets thereon. However, after time settling may occur, for example, because the threaded plates are supported at discrete points. In the case of vehicle doors, such setting may lead to undesirable noises or to unfavorable closing behavior. The threaded plate is usually installed and subsequently a conventional catalytic dip-coating of the vehicle body parts is carried out, that is used to apply a first coating layer which protects against corrosion and forms a key. One reason for the spotwise support may be what are referred to as buds which may lead to settling phenomena if the installed threaded plate sticks to a bearing surface. If, however, the threaded plate is fitted only in a later assembly step, after the dip-coating of the vehicle body parts, fitting becomes more difficult and, in addition to additional holders, also requires additional labor.

One object of the invention, therefore, is to provide a threaded plate in which the planar support of a planar basic body is improved and which can be processed in a production-efficient manner.

This and other objects and advantages are achieved by the threaded plate according to the invention, which comprises a planar basic body that has at least one spacer element protruding at an angle. The spacer element is provided for bearing against a bearing surface; when installed, it can prevent the threaded plate from sticking during a conventional catalytic dip-coating of a vehicle body, since the planar basic body can be kept at a defined distance from a bearing surface. The planar basic body comes into the bearing position when a component is screwed to the threaded plate, and is drawn by its supporting region onto the bearing surface by tightening a screw. In the process, the spacer element, which protrudes at an angle, is forced into a flatly aligned position. The distance between threaded plate and bearing surface is overcome, and the threaded plate bears with the planar basic body against the bearing surface.

This arrangement essentially avoids settling phenomena occurring later. The manufacture, for example of B-pillars of a vehicle body, on which door hinges and/or lock strikers are to be fixed by means of threaded plates, is improved. The threaded plate can be installed in a production-friendly manner before a dip-coating step. The installation of the threaded plate is simplified, and a cost saving is achieved by omitting additional holders.

If the spacer element is arranged in the edge region of the planar basic body, it can be used similarly to a holder, which facilitates the assembly of the threaded plate. The spacer element can advantageously be integral with the threaded plate and can be formed during production of the threaded plate.

If the spacer element is connected to the planar basic body by a predetermined buckling point, a bending movement is facilitated, and force is required in to change the angular position of the spacer element. The supporting surface of the planar basic body remains essentially level and can later form a planar contact with a bearing surface. Tightening a screw is likewise facilitated by a relatively small force opposing a bending of the spacer element back into a flat position.

If the predetermined buckling point is to have a smaller material thickness than the planar basic body, it can be produced at reasonable cost by a simple notching or stamping operation.

If the spacer element protrudes from the planar basic body at a flat angle, a sufficient distance of the planar basic body from a bearing surface is ensured. At the same time, the supporting region of the planar basic body of the threaded plate is still essentially level, so that the threaded plate protrudes at a sufficient distance from the bearing surface to prevent bonds, and the installation of the threaded plate is not obstructed. The spacer element is preferably angled in the direction of the side which lies opposite the threaded sleeve. However, depending on the intended use, it is also possible for the spacer element to be angled in the same direction as the threaded sleeve.

If the spacer element is designed as a yoke with two webs and a cross strut connecting the webs, it can be used during installation for better adjustment and handling. Furthermore, the predetermined buckling point can be arranged in the webs, so that the latter can easily be angled in one direction, and bent back again in the opposite direction. The spacer element may also be designed as an angled tab which is arranged in the bearing surface of the planar basic body.

The cross strut preferably forms a contact surface, and initially bears with an edge against the bearing surface. The resulting separation between planar basic body and bearing surface prevents the threaded plate from sticking during dip-coating.

If the planar basic body has two opposite spacer elements between which the threaded sleeve is arranged, a symmetrical arrangement can be created. The threaded plate then rests only against a bearing surface on the spacer elements, or in each case one of the edges thereof.

If the planar basic body has two or more threaded sleeves, a single threaded plate can be used to arrange a plurality of screw points on a vehicle body. The planar basic body thereby has a relatively large area and can be protected particularly favorably by the spacer element against sticking during the dip-coating operation. The threaded sleeves are preferably arranged between two opposite spacer elements. A threaded plate is, therefore, provided, which is compact and can easily be handled and, during installation, permits a defined distance between the planar basic body and the bearing surface.

The principle of the invention as described can also be used in an analogous manner in the case of other types of fixing.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic depiction of a B-pillar with installed threaded plate and door hinge;

FIG. 2 is a perspective view which shows a cut-out of a preferred threaded plate with a predetermined buckling point; and

FIG. 3 is a perspective view which shows a further preferred threaded plate with two threaded sleeves.

### DETAILED DESCRIPTION OF THE DRAWINGS

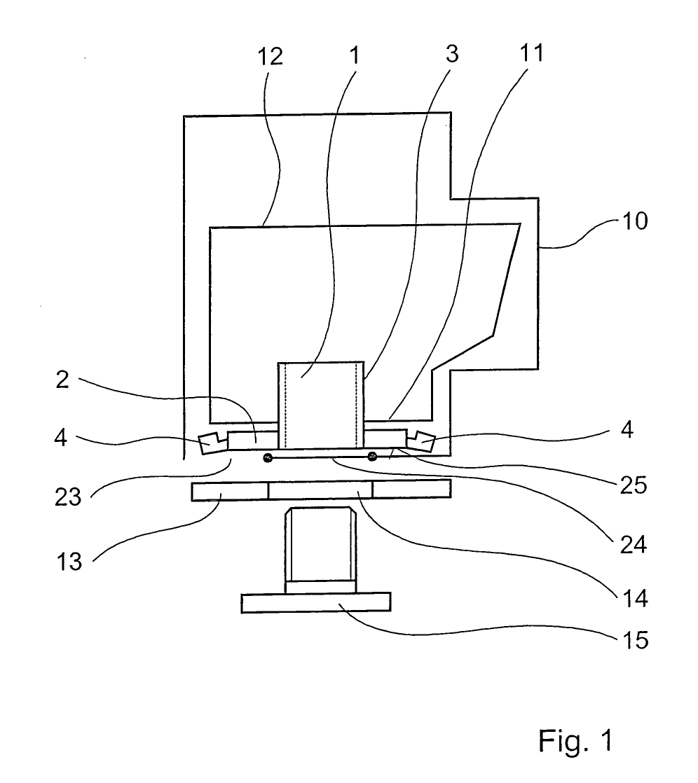

FIG. 1 shows, diagrammatically, the function of a threaded plate component 1 according to the invention in a B-pillar 10 of a vehicle body on which, for example, a hinge of a vehicle door or a lock striker for a vehicle door is to be fixed.

The threaded plate component 1 comprises a threaded sleeve 3 protruding from an essentially level supporting region 25 of a planar basic body 2; the planar basic body 2 has, on both sides of the threaded sleeve 3, a respective spacer element 4 protruding at an angle to one side. The spacer element 4 protrudes from the planar basic body 2 at a flat angle of less than 20° and thus ensures that the planar basic body 2 is at a distance from a bearing surface of the B-pillar 10. The threaded sleeve 3 protrudes to the side of the threaded plate 1 which is opposite the angled spacer element 4. A reinforcement 12 is provided within the B-pillar 10. The threaded plate 1 can be connected moveably to a carrying plate 11. At the location of installation of the threaded plate 1, the B-pillar has a bearing surface 23 for the threaded plate 1 with a suitable opening 24 through which a screw 15 can be screwed into the threaded sleeve 3. A fitting 13 which has a corresponding bore 14 is provided outside the B-pillar 10. The screw 15 is guided through the bore 14 and the opening 24 into the threaded sleeve 3 and is screwed down. When the screw 15 is tightened, the planar basic body 2 is drawn onto the bearing surface 23, and the spacer elements 4 are pressed flat. The planar basic body 2 then bears extensively with its supporting region 25 against the bearing surface 23, and the spacer elements 4 lie in a plane with the planar basic body 2.

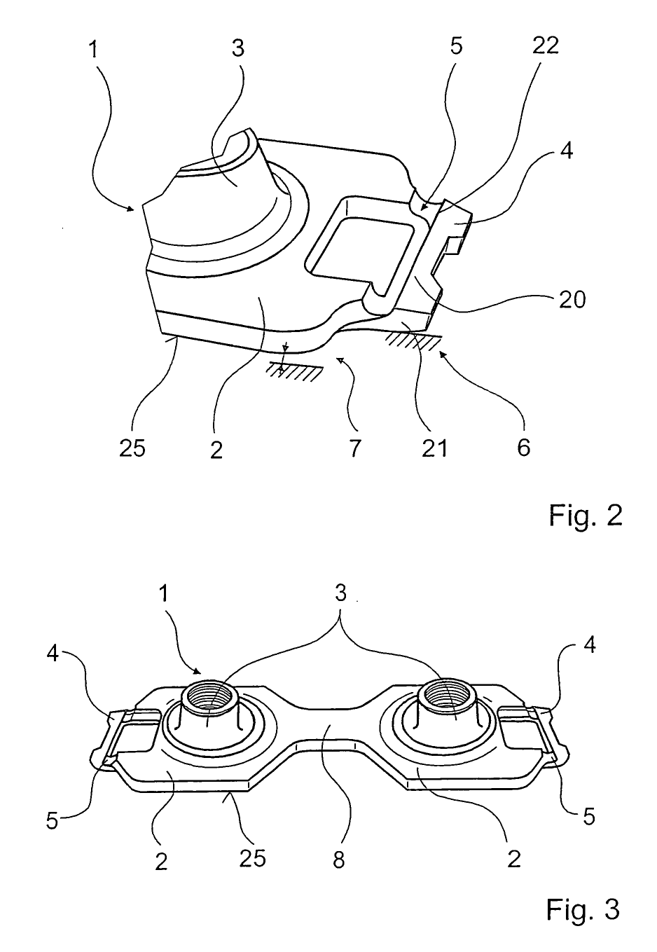

FIG. 2 shows a cut-out of a preferred threaded plate 1. A spacer element 4 is arranged on an edge of a planar basic body 2 and is connected to a supporting region 25 of the planar basic body 2 via a predetermined buckling point 5. The predetermined buckling point 5 has a smaller material thickness than the planar basic body 2. The spacer element 4 is designed as a yoke which is integrally formed on the supporting region 25 and has two webs 21, 22 and a cross strut 20 connecting the webs 21, 22. An edge 6 of the cross strut 20 forms a contact surface for the threaded plate 1 on a bearing surface. A distance 7 is formed between a bearing surface and a rear side of the planar basic body 2.

FIG. 3 shows a further preferred threaded plate 1. In this case, a planar basic body 2 has two opposite spacer elements 4 between which two threaded sleeves 3 are arranged. The spacer elements 4 and the two threaded sleeves 3 are arranged along a longitudinal extent 8 of the threaded plate 1. A supporting region 25 of the planar basic body 2 is constricted in its width between the two threaded sleeves 3. Weight can therefore be saved. Furthermore, access for a welding gun is possible at the constriction. The spacer elements 4 are designed as yokes and are connected to a supporting region 25 of the planar basic body 2 via predetermined buckling points 5.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A threaded plate component comprising:
a planar basic body; and
at least one threaded sleeve protruding from this basic body;
wherein the planar basic body has at least one spacer element protruding at an angle.

2. The threaded plate component as claimed in claim 1, wherein the at least one spacer element is arranged in an edge region of the planar basic body.

3. The threaded plate component as claimed in claim 2, wherein the spacer element is connected to a supporting region of the planar basic body via a predetermined buckling point.

4. The threaded plate component as claimed in claim 3, wherein the predetermined buckling point has a smaller material thickness than the planar basic body.

5. The threaded plate component as claimed in claim 1 wherein:
the at least one spacer element protrudes from the planar basic body at a shallow angle.

6. The threaded plate component as claimed in that claim 1, wherein:
the at least one spacer element is in the form of a yoke that is arranged on the planar basic body; and the yoke has two webs and a cross strut connecting the webs.

7. The threaded plate component as claimed in claim 6, wherein the cross strut forms a contact surface.

8. The threaded plate component as claimed in claim 1, wherein the planar basic body has opposite spacer elements between which the threaded sleeve is arranged.

9. The threaded plate component as claimed in claim 1, wherein two or more threaded sleeves are provided.
